(19) United States
(12) Patent Application Publication
(10) Pub. No.: US 2007/0291505 A1
(43) Pub. Date: Dec. 20, 2007

(54) Light source assembly with integrated optical pipe

(76) Inventors: Rance Fortenberry, Cazadero, CA (US); Peter Egerton, Windsor, CA (US); Rad Sommer, Sebastopol, CA (US); Mike Scobey, Santa Rosa, CA (US); Brett Bryars, Santa Rosa, CA (US)

Correspondence Address: THE LAW OFFICE OF STEVEN G ROEDER, 5560 CHELSEA AVE, LA JOLLA, CA, 92037, US

(21) Appl. No.: 11/501,923

(22) Filed: Aug. 9, 2006

Related U.S. Application Data
(60) Provisional application No. 60/810,317, filed on Jun. 2, 2006.

(51) Int. Cl. F21S 4/00

(52) U.S. Cl. 362/583

(57) ABSTRACT

A light source assembly (212) for providing a homogenized light beam (224) includes a first light source (234), a second light source (236), and an optical pipe (228) that defines a pipe passageway (228A). The first light source (234) generates a first light (234A) that is directed into the pipe passageway (228A) at a first region (228I). The second light source (236) generates a second light (236A) that is directed into the pipe passageway (228A) at a second region (228H) that is different than the first region (228I). The optical pipe (228) homogenizing the first light (234A) and the second light (236A). Additionally, the light source assembly (212) can include a third light source (238) that generates a third light (238A) that is directed into the optical pipe (228) at a third region (228G) that is different than the first region (228I) and the second region (228H).

### RELATED APPLICATION

This application claims priority on U.S. Provisional Application Ser. No. 60/810,317 filed on Jun. 2, 2006 and entitled “LIGHT SOURCE ASSEMBLY WITH INTEGRATED OPTICAL PIPE”. The contents of U.S. Provisional Application Ser. No. 60/810,317 are incorporated herein by reference.

### BACKGROUND

Light sources provide light for projection systems and other optical equipment. One type of projection system is a Digital Mirror Device. A typical Digital Mirror Device can include a light source, a color wheel, a light homogenizer (light pipe), a mirror, an imager, a lens, and a screen that cooperate to generate an image on a screen. Currently, many Digital Mirror Devices use a UHP arc lamp as the light source. Unfortunately, the arc lamp has a relatively large etendue, emits over a broad spectrum (but low in red content), has a relatively short operational life.

### SUMMARY

A light source assembly for providing a homogenized light beam includes a first light source, a second light source, and an optical pipe that defines a pipe passageway. The first light source generates a first light that is directed into the pipe passageway at a first region. The second light source generates a second light that is directed into the pipe passageway at a second region that is different than the first region. The optical pipe homogenizes the first light and the second light. With this design, the present invention provides a way to combine multiple lights to generate a uniform light beam with a relatively small package.

Additionally, the light source assembly can include a third light source that generates a third light that is directed into the optical pipe at a third region that is different than the first region and the second region. In this embodiment, the optical pipe homogenizes the first light, the second light, and the third light. With this design, one of the light sources can be a red LED that generates red light, one of the light sources can be a blue LED that generates blue light, and one of the light sources can be a green LED that generates green light.

Additionally, the light source assembly can include a blue pass filter that is positioned between the blue LED and the pipe passageway. The blue pass filter (i) transmits a high percentage of blue light that is within a blue predetermined angle of incidence range, (ii) reflects a high percentage of blue light that is outside the blue predetermined angle of incidence range, (iii) reflects a high percentage of green light, and (iv) reflects a high percentage of red light.

Moreover, the light source assembly can include a green pass filter that is positioned between the green LED and the pipe passageway. The green pass filter (i) transmits a high percentage of green light that is within a green predetermined angle of incidence range, (ii) reflects a high percentage of green light that is outside the green predetermined angle of incidence range, and (iii) reflects a high percentage of red light.

The light source assembly can also include a blue dichroic filter and/or a green dichroic filter positioned in the pipe passageway. The blue dichroic filter (i) transmits a high percentage of red light and green light, and (ii) reflects a high percentage of blue light. The green dichroic filter (i) transmits a high percentage of red light, and (ii) reflects a high percentage of green light.

In one embodiment, (i) the first light source directs the first light into the pipe passageway transverse to a passageway axis of the pipe passageway, and/or (ii) the second light source directs the second light into the pipe passageway transverse to the passageway axis of the pipe passageway. In one embodiment, the first light and the second light are directed into the pipe passageway at an angle that is approximately 90 degrees relative to the passageway axis.

Additionally, the present invention is directed to a light source assembly that includes (i) an optical pipe that defines a pipe passageway; (ii) a red LED that generates a red light that is directed into the pipe passageway at a first region; (iii) a green LED that generates a green light that is directed into the pipe passageway at a second region that is different than the first region; (iv) a green pass filter positioned between the green LED and the pipe passageway, the green pass filter (a) transmitting a high percentage of green light that is within a green predetermined angle of incidence range, (b) reflecting a high percentage of green light that is outside the green predetermined angle of incidence range, and (c) reflecting a high percentage of red light; (v) a blue LED that generates a blue light that is directed into the pipe passageway at a third region that is different than the first region and the second region; and (vi) a blue pass filter positioned between the blue LED and the pipe passageway, the blue pass filter (a) transmitting a high percentage of blue light that is within a blue predetermined angle of incidence range, (b) reflecting a high percentage of blue light that is outside the blue predetermined angle of incidence range, (c) reflecting a high percentage of green light, and (d) reflecting a high percentage of red light.

The present invention is also directed to a method for generating a homogenized light beam for a precision apparatus. The method can include the steps of (i) generating a first light with a first light source; (ii) generating a second light with a second light source; and (iii) homogenizing the first light and the second light with an optical pipe that defines a pipe passageway. In this embodiment, the first light is directed into the pipe passageway at a first region, and the second light is directed into the pipe passageway at a second location that is different than the first region.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified perspective illustration of a precision apparatus having features of the present invention;

FIG. 2A is a perspective view of a light source assembly having features of the present invention;

FIG. 2B is a cut-away view of the light source assembly of FIG. 2A;

FIG. 3 is a cut-away view of another embodiment of a light source assembly having features of the present invention;

FIG. 4 is a cut-away view of yet another embodiment of a light source assembly having features of the present invention;

FIG. 5 is a cut-away view of still another embodiment of a light source assembly having features of the present invention;

FIG. 6 is a cut-away view of another embodiment of a light source assembly having features of the present invention;

FIG. 7 is a cut-away view of yet another embodiment of a light source assembly having features of the present invention;

FIGS. 8A and 8B are alternative graphs that illustrate the properties of alternative pass filters having features of the present invention; and

FIG. 9 is a chart that lists the layer of materials for making a filter having features of the present invention.

### DESCRIPTION

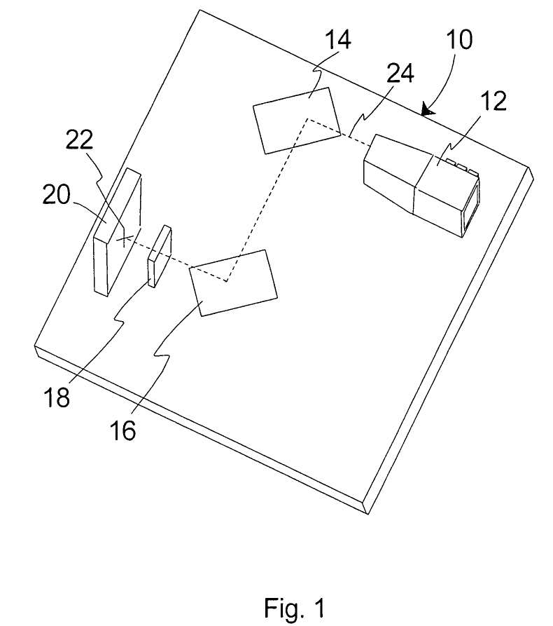

Referring initially to FIG. 1, the present invention is directed to a precision apparatus 10 that, for example, can be used as or in optical communications, light projection systems, scientific instruments and manufacturing equipment. FIG. 1 is a simplified, non-exclusive, perspective view of one embodiment of the precision apparatus 10. In this embodiment, the precision apparatus 10 is a light projection system, commonly referred to as a Digital Mirror Device (“DMD system”). Alternatively, for example, the precision apparatus 10 can be another type of apparatus that uses a light beam. For example, the present invention can be used in another type of projection system such as a Liquid Crystal Display (LCD) system or a Liquid Crystal on Silicon (LCOS) system.

In FIG. 1, the precision apparatus 10 includes a light source assembly 12, a mirror 14, an imager 16, a lens 18, and a screen 20 that cooperate to generate an image 22 (represented as an “X”) on the screen 20. The design and orientation of the components of the precision apparatus 10 can be changed to suit the requirements of the precision apparatus 10. Further, the precision apparatus 10 can be designed with fewer or more components than those illustrated in FIG. 1.

The light source assembly 12 generates a light 24 for the projection system 10. As an overview, in certain embodiments, the light source assembly 12 generates a homogenized, incoherent bright white light 24 that includes blue light, green light and red light. As a result thereof, in certain embodiments, one or more components, such as a color wheel is not required for the DMD system. Further, in one embodiment, multiple light beams are multiplexed in a light pipe. With this design, the light source assembly 12 can be controlled to generate an output beam having any desired color, including red, blue, green, or white.

Moreover, in certain embodiments, the light source assembly 12 can be designed to efficiently generate the light 24 with relatively low power. This reduces the amount of heat generated by the light source assembly 12 and improves the performance of the precision apparatus 10. Additionally, the light source assembly 12 has a relatively long operational lifespan, has good power stability, and is relatively small in size.

The mirror 14 reflects the light 24 exiting from the light source assembly 12 and directs the light 24 at the imager 16.

The imager 16 creates the image 22. In one embodiment, the imager 16 is a digital light processing chip that includes anywhere from approximately 800 to more than 1 million tiny mirrors that are individually controlled to generate the image 22. Alternatively, for example, the imager 22 can be a LCD imager or a LCOS imager.

The lens 18 collects the image 22 from the imager 16 and focuses the image 22 on the screen 20. The screen 20 displays the image 22.

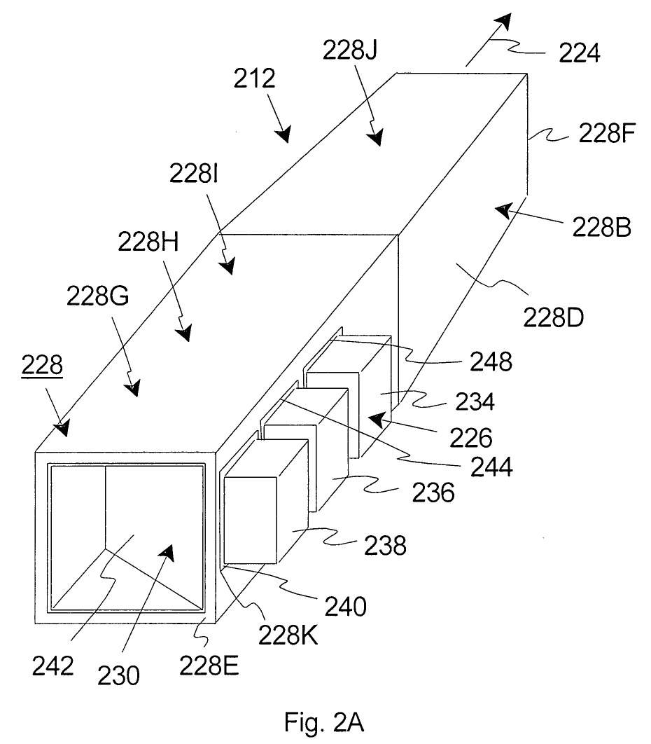

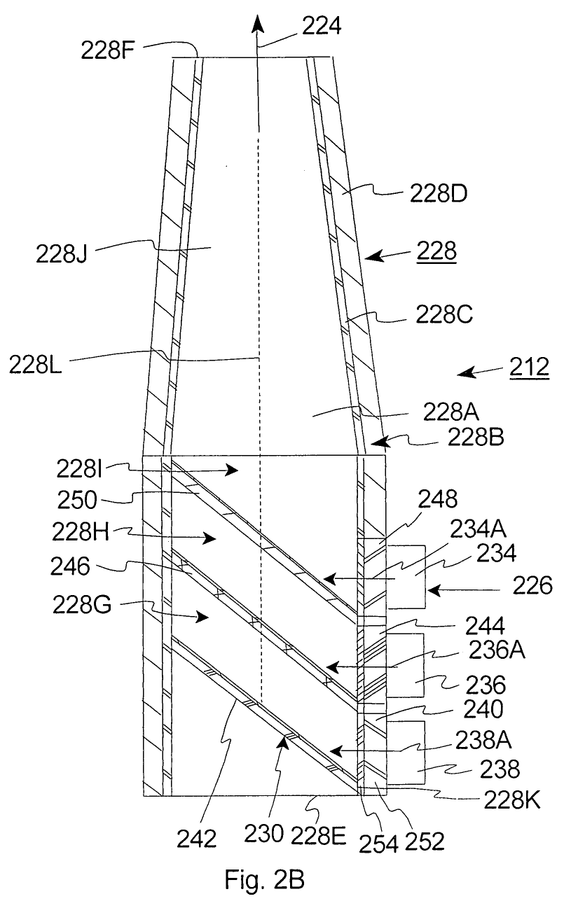

FIG. 2A is a perspective view and FIG. 2B is a cut-away view of one embodiment a light source assembly 212 that can be used in a precision apparatus 10 (illustrated in FIG. 1). In this embodiment, the light source assembly 212 includes a plurality of light sources 226, an optical pipe 228, and a director assembly 230.

The number and design of the light sources 226 can be varied pursuant to the teachings provided herein. In one embodiment, the light source assembly 212 includes three separate light sources 226, namely a blue light source 234 (illustrated as a box) that generates blue light 234A (illustrated as an arrow), a green light source 236 (illustrated as a box) that generates green light 236A (illustrated as an arrow), and a red light source 238 (illustrated as a box) that generates red light 238A (illustrated as an arrow). The blue light 234A has a wavelength of between approximately 450-490 nm, the green light 236A has a wavelength of between approximately 490-570 nm, and the red light 238A has a wavelength of between approximately 630-700 nm. Alternatively, the light source assembly 212 could be designed with greater than or fewer than three light sources 236.

It should be noted that the blue light source 234, the green light source 236, and/or the red light source 238 can be referred to herein as the first light source, the second light source, or the third light source. Further, the blue light 234A, the green light 236A, and/or the red light 238A can be referred to herein as the first light, the second light, or the third light.

In one embodiment, each of the light sources 226 is a light emitting diode (“LED”). In this example, the blue light source 234 is a blue LED, the green light source 236 is a green LED, and the red light source 238 is a red LED. In one non-exclusive embodiment, the blue light source 234 has an output of between approximately 100 to 200 lumen, the green light source 236 has an output of between approximately 900 to 1100 lumen, and the red light source 238 has an output of between approximately 300 to 500 lumen. Alternatively, each of the light sources 234, 236, 238 can be designed to have an output that is greater or lesser than the amounts described above.

In one embodiment, each of light sources 234, 236, 238 is turned on and off is sequence. As a result thereof, a color wheel (not shown) may not be necessary for a DMD system. This allows for a smaller form factor for the DMD system and can reduce the cost for assembly of the DMD system. Moreover, the LED's have a relatively long operational lifespan. Alternatively, the light sources 234, 236, 238 can be maintained on and a color wheel can be utilized. Further, the light sources 234, 236, 238 can be controlled to generate an output light 224 having any desired color, including red, blue, green, or white.

The optical pipe 228 captures the lights 234A, 236A, 238A and homogenizes the lights 234A, 236A, 238A so that the output light 224 exiting the light source assembly 212 is uniform, consistent, and has the desired aspect ratio. Optical pipes are also sometimes referred to as light tunnels or tunnel integrators. The design of the optical pipe 228 can be varied pursuant to the teachings provided herein. FIGS. 2A and 2B illustrate a first embodiment of the optical pipe 228. In this embodiment, the optical pipe 228 is generally rectangular tube shaped and defines a generally rectangular shaped pipe passageway 228A.

Further, in this embodiment, the pipe passageway 228A (i) is substantially linear and includes a substantially linear passageway axis 228L, (ii) does not include any bends, and (iii) the light 234A, 236A, 238A from the light sources 234, 236, 238 travel down the same pipe passageway 228A. As a result of this design, in certain embodiments, the profile of the light source assembly 212 can be relatively small. Alternatively, pipe passageway 228A can include one or more bends. For example, the pipe passageway 228A can include one or more 90 degree bends.

In one embodiment, the optical pipe 228 includes a generally rectangular tube shaped pipe body 228B and a wall coating 228C that define the generally rectangular shaped pipe passageway 228A. The pipe body 228B can include four walls 228D, with each of the walls 228D having an interior wall surface and an exterior wall surface. The four walls 228D can be referred to as a top wall, a bottom wall, a left wall, and a right wall for convenience. Alternatively, for example, the pipe body 228B can have another configuration, such as a circular shaped tube, an octagon shaped tube, or a triangular shaped tube for example.

In one embodiment, the interior wall surfaces are coated with the wall coating 228C. For example, the wall coating 228C can have a relatively high reflectivity for the visible wavelength range (approximately 400-750 nm). With this design, the wall coating 228C inhibits the light 224 from exiting the pipe passageway 228A and homogenizes the light 224. Suitable wall coatings 228C can include dielectric materials and/or metal (silver or aluminum) material.

The wall coating 228C may have to be applied with multiple coating layers, and can be deposited using a number of different methods including physical vapor deposition such as ion beam sputtering, magnetron sputtering, and ion assisted evaporation. One method for depositing a coating is disclosed in U.S. Pat. No. 6,736,943, the contents of which are incorporated herein by reference.

Moreover, in this embodiment, the optical pipe 228 includes (i) a leading edge 228E, (ii) an opposed trailing edge 228F (sometimes referred to as the “output end”) that faces the mirror 14 (illustrated in FIG. 1), (iii) a red region 228G, (iv) a green region 228H, (v) a blue region 228I, and (vi) a homogenizing region 228J. The design and location of each of these regions 228B-228E can be varied pursuant to the teachings provided herein.

The red light 238A is directed into the optical pipe 228 at the red region 228G, the green light 236A is directed into the optical pipe 228 at the green region 228H, and the blue light beam 234A is directed into the optical pipe 228 at the blue region 228I. In FIGS. 2A and 2B, the red region 228G, the green region 228H, and the blue region 228I is each generally rectangular tube shaped and each includes a region aperture 228K (sometimes referred to as an inlet port) that receives a portion of the director assembly 230 (in certain embodiments) and that extends through the front wall 228D. Alternatively, one or more of these regions 228G-228I can have another configuration. It should be noted that the red region 228G, the green region 228H, and/or the blue region 228I can be referred to herein as the first region, the second region, or the third region. Further, the region apertures 228K are spaced apart and can be referred to as the first inlet port, the second inlet port, the third inlet. Further, the region aperture 228K in the red region 228G can be referred to as the red inlet port, the region aperture 228K in the green region 228H can be referred to as the green inlet port, and the region aperture 228K in the blue region 228I can be referred to as the blue inlet port.

The homogenizing region 228J homogenizes the light 234A, 236A, 238A that travel down the pipe passageway 228A. In FIGS. 2A and 2B, the homogenizing region 228J is generally tapered rectangular tube shaped and the light 234A, 236A, 238A from each of the sources travels down the same path. As a result thereof, the light 224 is generally rectangular shaped. Alternatively, the homogenizing region 228J can have another configuration to suit the desired aspect ratio of the light beam 224.

In FIGS. 2A and 2B, the red region 228G, the green region 228H, the blue region 228I, and the homogenizing region 228J are illustrated as a continuous piece. Alternatively, one or more of these regions 228G-228J can be made separately and subsequently attached to the other regions 228G-228J.

Moreover, in FIGS. 2A and 2B, moving from the leading edge 228E to the trailing edge 228F the regions are organized as the red region 228G, the green region 228H, the blue region 228I, and the homogenizing region 228J. In this embodiment, moving from the leading edge 228E to the trailing edge 228F, the regions 228G, 228H, 228I are organized so that the longest wavelength light enters the pipe passageway 238A closest to the leading edge 228E and the shortest wavelength light enters the pipe passageway 238A closest to the trailing edge 228F. Stated in another fashion, moving from the leading edge 228E to the trailing edge 228F, the light sources 234, 236, 238 are organized so that the light enters the pipe passageway 238A from longest wavelengths to the shortest wavelengths. With this design, the red light 238A enters the pipe passageway 238A closest to the leading edge 228E, the blue light 234A enters the pipe passageway 238A closest to the trailing edge (exit) 228F, and the green light 236A enters the pipe passageway 238A intermediate where the red light 238A and the blue light 234A enters the pipe passageway 238A. This simplifies the design of one or more of the filters of the director assembly 230. Alternatively, the orientation of the red region 228G, the green region 228H, and the blue region 228I can be different than that illustrated in the Figures.

The director assembly 230 allows the desired light to enter the pipe passageway 228A and directs the desired light down the pipe passageway 228A. The design of the director assembly 230 can vary pursuant to the teachings provided herein. In FIGS. 2A and 2B, the director assembly 230 includes (i) a red pass filter 240, (ii) an end reflector 242, (iii) a green pass filter 244, (iv) a green Dichroic filter 246, (v) a blue pass filter 248, and (vi) a blue Dichroic filter 250. Alternatively, the director assembly 230 could be designed to have more components or fewer components than those illustrated in FIGS. 2A and 2B.

It should be noted that the red pass filter 240, the green pass filter 244, and/or the blue pass filter 248 can be referred to as a first pass filter, a second pass filter, or a third pass filter. These pass filters 240, 244, 248 keep light that has entered the pipe passageway 228A in the pipe passageway 228A to enhance the efficiency of the assembly. It should also be noted that the green Dichroic filter 246 or the blue Dichroic filter 250 can be referred to as a first Dichroic filter or a second Dichroic filter.

The red pass filter 240 is positioned between the red light source 238 and the pipe passageway 228A, allows red light 238A from the red light source 238 to enter the pipe passageway 228A, and inhibits red light 238A in the pipe passageway 228A from exiting via the red pass filter 240. In one embodiment, the red pass filter 240 is capable of (i) transmitting a high percentage of red light that is within a red predetermined angle of incidence range, (ii) reflecting a high percentage red light that is outside the red predetermined angle of incidence range, (iii) reflecting a high percentage of blue light, and (iv) reflecting a high percentage of green light. In alternative, non-exclusive embodiments, the red predetermined angle of incidence range is between approximately 0 to 50; 0 to 45; 0 to 30; 0 to 20; 0 to 10; or 0 to 5 degrees.

Further, in alternative, non-exclusive embodiments, the phrase “transmitting a high percentage” shall mean an average transmittance of greater than approximately 85, 90, 95, 96, 97, 98, or 99. Moreover, in alternative, non-exclusive embodiments, phrase “reflecting a high percentage” shall mean an average reflection of greater than approximately 85, 90, 95, 96, 97, 98, or 99.

In FIGS. 2A and 2B, the red pass filter 240 is positioned in the region aperture 228K in the wall 228D of the pipe body 228B at the red region 228G. In one embodiment, the red pass filter 240 is generally rectangular plate shaped and fits into the rectangular shaped region aperture 228K. Alternatively, the red pass filter 240 can have another configuration. As illustrated in FIG. 2B, in one embodiment, the red light 238A is directed into the pipe passageway 228A substantially transverse to the passageway axis 228L of the pipe passageway 228A. As used herein, the term transverse shall mean at an angle relative to the passageway axis. For example, the red light 238A can be directed into the pipe passageway 228A at an angle of approximately 90 degrees relative to the passageway axis 228L. Alternatively, the red light 238A can be directed into the pipe passageway 228L at angles other than 90 degrees.

The end reflector 242 reflects the red light 238A and directs the red light 238A along the pipe passageway 228A. In FIGS. 2A and 2B, the end reflector 242 extends across the pipe passageway 228A at an angle (e.g. approximately 45 degrees in one embodiment) and reflects substantially all light that is within the visible wavelengths towards the trailing edge 228E. Additionally, the end reflector 242 is positioned at the edge of the red region 228G. In one embodiment, the end reflector 242 is generally rectangular plate shaped and has a size and shape that corresponds to that of the pipe passageway 228A.

The green pass filter 244 is positioned between the green light source 236 and the pipe passageway 228A, allows green light 236A from the green light source 236 to enter the pipe passageway 228A, and inhibits green light 236A and red light 238A in the pipe passageway 228A from exiting via the green pass filter 244. In one embodiment, the green pass filter 244 is capable of (i) transmitting a high percentage of green light that is within a green predetermined angle of incidence range, (ii) reflecting a high percentage green light that is outside the green predetermined angle of incidence range, (iii) reflecting a high percentage of blue light, and (iv) reflecting a high percentage of red light. In alternative, non-exclusive embodiments, the green predetermined angle of incidence range is between approximately 0 to 50; 0 to 45; 0 to 30; 0 to 20; 0 to 10; or 0 to 5 degrees.

In FIGS. 2A and 2B, the green pass filter 244 is positioned in the region aperture 228K in the wall 228D of the pipe body 228B at the green region 228H. In one embodiment, the green pass filter 244 is generally rectangular plate shaped and fits into the rectangular shaped region aperture 228K. Alternatively, the green pass filter 244 can have another configuration. As illustrated in FIG. 2B, in one embodiment, the green light 236A is directed into the pipe passageway 228A substantially transverse to the passageway axis 228L. For example, the green light 236A can be directed into the pipe passageway 228A at an angle of approximately 90 degrees relative to the passageway axis 228L. Alternatively, the green light 236A can be directed into the pipe passageway 228L at angles other than 90 degrees.

The green dichroic filter 246 reflects the green light 236A and directs the green light 236A along the pipe passageway 228A while allowing red light 238A to pass therethrough. In FIGS. 2A and 2B, the green dichroic filter 246 extends across the pipe passageway 228A at an angle (e.g. approximately 45 degrees in one embodiment) between the red inlet port and the green inlet port, and reflects substantially all green light 236A towards the trailing edge 228E. Additionally, the green dichroic filter 246 is positioned between the red region 228G and the green region 228H. In one embodiment, the green dichroic filter 246 is generally rectangular plate shaped and has a size and shape that corresponds to that of the pipe passageway 228A.

The blue pass filter 248 is positioned between the blue light source 234 and the pipe passageway 228A, allows blue light 234A from the blue light source 234 to enter the pipe passageway 228A, and inhibits blue light 234A, green light 236A, and red light 238A in the pipe passageway 228A from exiting via the blue pass filter 248. In one embodiment, the blue pass filter 248 is capable of (i) transmitting a high percentage of blue light that is within a blue predetermined angle of incidence range, (ii) reflecting a high percentage blue light that is outside the blue predetermined angle of incidence range, (iii) reflecting a high percentage of green light, and (iv) reflecting a high percentage of red light. In alternative, non-exclusive embodiments, the blue predetermined angle of incidence range is between approximately 0 to 50; 0 to 45; 0 to 30; 0 to 20; 0 to 10; or 0 to 5 degrees.

In FIGS. 2A and 2B, the blue pass filter 248 is positioned in the region aperture 228K in the wall 228D of the pipe body 228B at the blue region 228I. In one embodiment, the blue pass filter 248 is generally rectangular plate shaped and fits into the rectangular shaped region aperture 228K. Alternatively, the blue pass filter 248 can have another configuration. As illustrated in FIG. 2B, in one embodiment, the blue light 234A is directed into the pipe passageway 228A substantially transverse to the passageway axis 228L. For example, the blue light 234A can be directed into the pipe passageway 228A at an angle of approximately 90 degrees relative to the passageway axis 228L. Alternatively, the blue light 234A can be directed into the pipe passageway 228L at angles other than 90 degrees.

The blue dichroic filter 250 reflects the blue light 234A and directs the blue light 234A along the pipe passageway 228A while allowing red light 238A and green light 236A to pass therethrough. In FIGS. 2A and 2B, the blue dichroic filter 250 extends across the pipe passageway 228A at an angle (e.g. approximately 45 degrees in one embodiment) between the green inlet port and the blue inlet port, and reflects substantially all blue light 234A towards the trailing edge 228E. Additionally, the blue dichroic filter 250 is positioned between the green region 228H and the blue region 228I. In one embodiment, the blue dichroic filter 250 is generally rectangular plate shaped and has a size and shape that corresponds to that of the pipe passageway 228A.

Further, in one embodiment, the green dichroic filter 246 and the blue dichroic filter 250 are arranged in series along the linear passageway axis 228L. This can reduce the footprint of the light source assembly 212. Moreover, one or both of the dichroic filters 246, 250 can be an interference filter and can have a high effective index (n greater than approximately 1.75) to provide improved response for the tilted coatings. As described above, each dichroic filter 246, 250 can be a plate type filter. In one embodiment, a plate type filter is an interference filter deposited onto a parallel plate substrate (e.g. glass). The plate type dichroic filter may be designed to have a high effective refractive index to improve filter response when tilted at angles to incident light.

The design of each of the red pass filter 240, the end reflector 242, the green pass filter 244, the green Dichroic filter 246, the blue pass filter 248, and the blue Dichroic filter 250 can be varied pursuant to the teachings provided herein. In one embodiment, each of the components includes a substrate 252 and coating 254 that coats the substrate 252. As an example, the substrate 252 can be a piece of glass or other transparent material. The coating 254 for each of the components is uniquely designed to achieve the desired level of reflectance for each of these components. Suitable coatings 254 can include dielectric materials and/or metal (silver or aluminum) material. The coatings 254 may have to be applied with multiple coating layers, and can be deposited using a number of different methods including physical vapor deposition such as ion beam sputtering, magnetron sputtering, and ion assisted evaporation. One method for depositing the coatings 254 is disclosed in U.S. Pat. No. 6,736,943.

In one embodiment, each of the pass filters 240, 244, 248 is built as an edge filter using thin film interference technology. The edge filter is designed to transmit at normal incidence (perpendicular to the filter) or near-normal incidence at the desired pass color (wavelength) while reflecting all other colors. Furthermore, the filter also reflects the desired color at non-normal angles. This is done using the angle shifting properties of thin films where at high angles, the edge, reflection bands and passbands of the filter shifts to shorter wavelengths. The shifting of the reflection bands provides the desired effect of having the same color which transmits at normal to be substantially reflected at non-normal wavelengths. Using these techniques, the pass filters 240, 244, 248 can also be designed to transmit a wavelength at normal (perpendicular to the filter), and reflect the wavelength at relatively high angles.

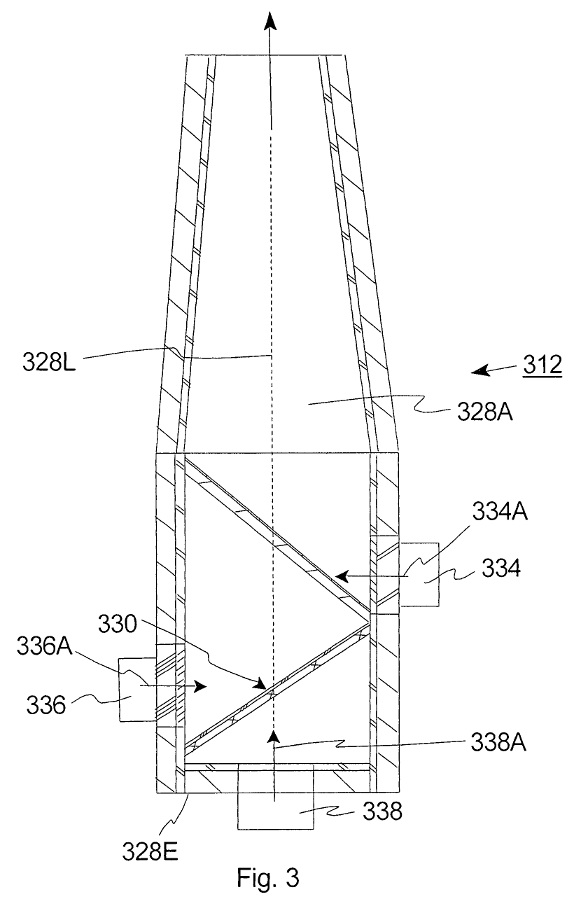

FIG. 3 is a cut-away view of another embodiment of a light source assembly 312 that is somewhat similar to the light source assembly 212 illustrated in FIGS. 2A and 2B and described above. However, in this embodiment, the red light source 338 is are located at the leading edge 328E and the red light source 338 directs the red light 338A along the passageway axis 328L. Moreover, the director assembly 330 does not include the end reflector 242 because in this configuration, there is no need to redirect the red light 338A. Additionally, this design does not include the red pass filter because the red light 338A enters the pipe passageway 328 along the passageway axis 328L and very little red light 338A is reflected back at the red light source 338.

Furthermore, in FIG. 3, the green light source 336 and the blue light source 334 are located in alternative sides of the passageway axis 328L. With this design, the blue light 334A and the green light 336A enter the pipe passageway 328A at an angle (perpendicular in one example) relative to the passageway axis 328L and the red light 338A enters the pipe passageway 328A aligned (parallel) with the passageway axis 328L. Stated in another fashion, in one embodiment, the red light 338A enters the pipe passageway 328A at an angle of approximately 90 degree angle relative to the blue light 334A and the green light 336A, and the green light 336A enters the pipe passageway 328A at an angle of approximately 180 degree angle relative to the blue light 334A. However, other angles can be utilized.

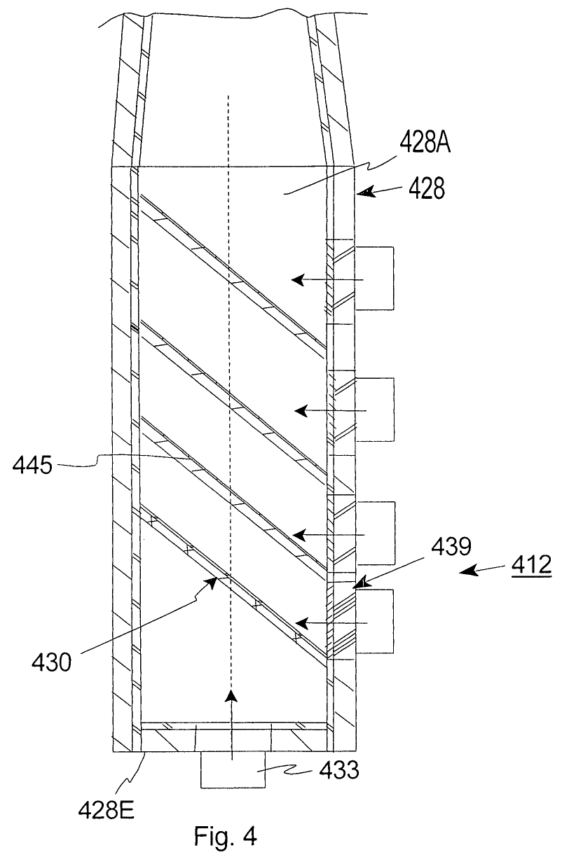

FIG. 4 is a cut-away view of yet another embodiment of a light source assembly 412 including an optical pipe 428, five spaced apart light sources 433 and the director assembly 430 include four pass filters 439 and four dichroic filters 445. In this embodiment, extra colors can improve color and brightness of the light source assembly 412. Alternatively, the light source assembly 412 could be designed with greater than or fewer than five spaced apart light sources 433 and/or greater than or fewer than four pass filters 439 and four dichroic filters 445.

In one embodiment, the light sources 433 include a red LED, a magenta LED, a green LED, a cyan LED, and a blue LED. Alternatively, other colors can be utilized.

In one embodiment, moving from the leading edge 428E to the trailing edge (not shown in FIG. 4), the light sources 433 can be are organized so that the light enters the pipe passageway 428A from longest wavelengths to the shortest wavelengths.

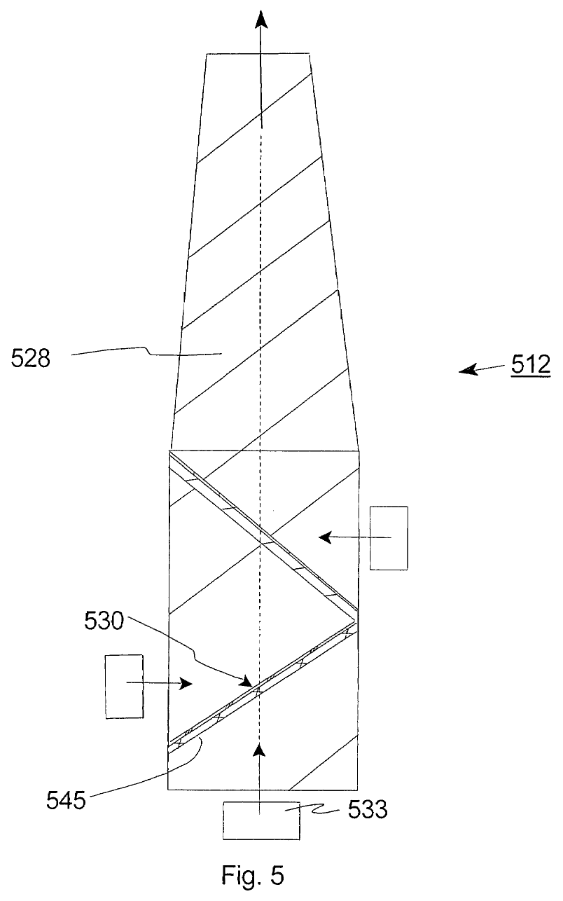

FIG. 5 is a cut-away view of still another embodiment of a light source assembly 512 that includes the optical pipe 528 and three light sources 533. In this embodiment, the optical pipe 528 is a solid light pipe. For example, the optical pipe 528 can be a polished, rectangular shaped piece of glass or other material. Further, in the embodiment, the director assembly 530 includes two dichroic filters 545 that are embedded into the optical pipe 528. The dichroic filters 545 can be molded with the optical pipe 528.

Additionally, in this embodiment, the director assembly 530 does not include any pass filters. More specifically, in this embodiment, light that enters the solid light pipe continues to travel in the light pipe using total internal reflection. Alternatively, one or more pass filters can be used that function as an anti-reflection coating at normal and a reflector at high angles.

In FIG. 5, the light sources 533 are illustrated as being spaced apart from the optical pipe 528. Alternatively, the light sources 533 can be positioned against the optical pipe 528 and fixedly secured to the optical pipe 528.

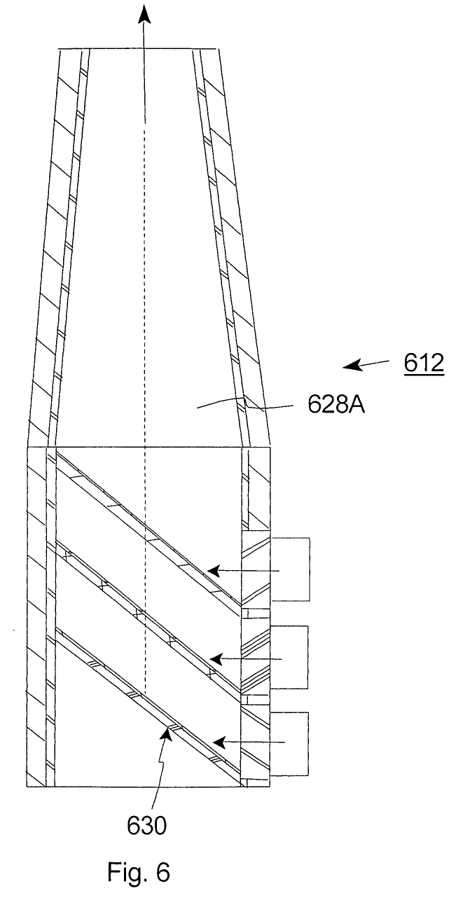

FIG. 6 is a cut-away view of another embodiment of a light source assembly 612 that is somewhat similar to the light source assembly 212 illustrated in FIGS. 2A and 2B and described above. However, in this embodiment, the director assembly 630 is slightly different. More specifically, in this embodiment, the director assembly 630 does not include (i) the red pass filter 240 (illustrated in FIG. 2B), (ii) the green pass filter 244 (illustrated in FIG. 2B), or (iii) the blue pass filter 248 (illustrated in FIG. 2B). In this embodiment, the pass filters 240, 244, 248 have been replaced with a transparent material such as glass. Alternatively, the ports can be open.

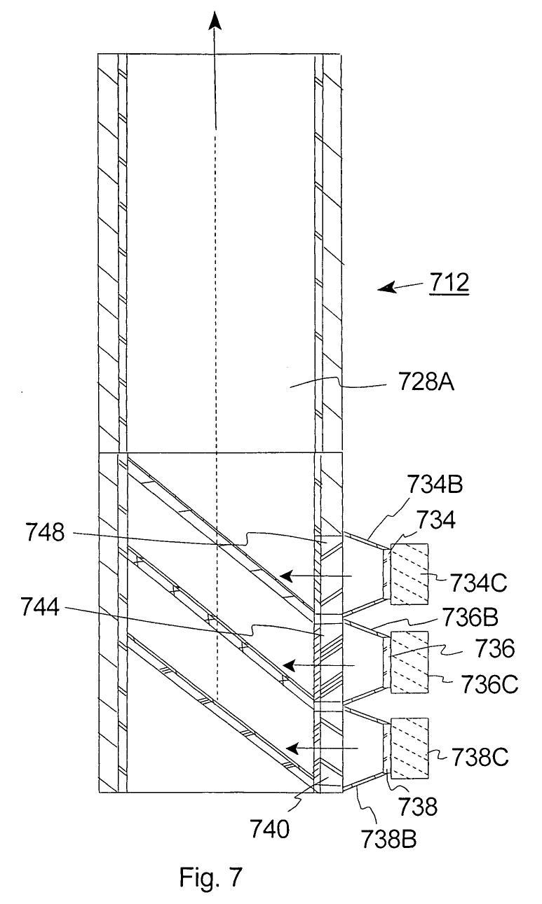

FIG. 7 is a cut-away view of another embodiment of a light source assembly 712 that is somewhat similar to the light source assembly 212 illustrated in FIGS. 2A and 2B and described above. However, in this embodiment, the light source assembly 712 includes (i) a blue collimator 734B positioned between the blue light source 734 and the blue pass filter 248, (ii) a blue heat sink 734C that cools the blue light source 734, (iii) a green collimator 736B positioned between the green light source 736 and the green pass filter 244, (iv) a green heat sink 736C that cools the green light source 736, (v) a red collimator 738B positioned between the red light source 738 and the red pass filter 740, and (vi) a red heat sink 738C that cools the red light source 738. Alternatively, the light source assembly 712 could be designed without one or more of the collimators and/or the heat sinks.

Each collimator 734B, 736B, 738B collimates the light from the respective light source 734, 736, 738 so that the light entering the pipe passageway 728A is largely collimated. The design of each collimator 734B, 736B, 738B can vary. In one embodiment, each of the collimators 734B, 736B, 738B is tapered light pipe collimator. Alternatively, one or more of the collimators 734B, 736B, 738B can be a lens type collimator or a total internal reflection type collimator.

Each heat sink 734C, 736C, 738C removes heat from the respective light source 734, 736, 738. The design of each heat sink 734C, 736C, 738C can vary. In one embodiment, the heat sink 734C, 736C, 738C can include a plurality of spaced apart fins.

Further, in the embodiment illustrated in FIG. 7, the pipe passageway 728A has a slightly different shape than that illustrated in FIGS. 2A and 2B. In particular, in this embodiment, the pipe passageway 728A is not tapered.

It should be noted that one or more of the collimators 734B, 736B, 738B and/or one or more of the heat sinks 734C, 736C, 738C can be incorporated into one or other embodiments described or illustrated herein.

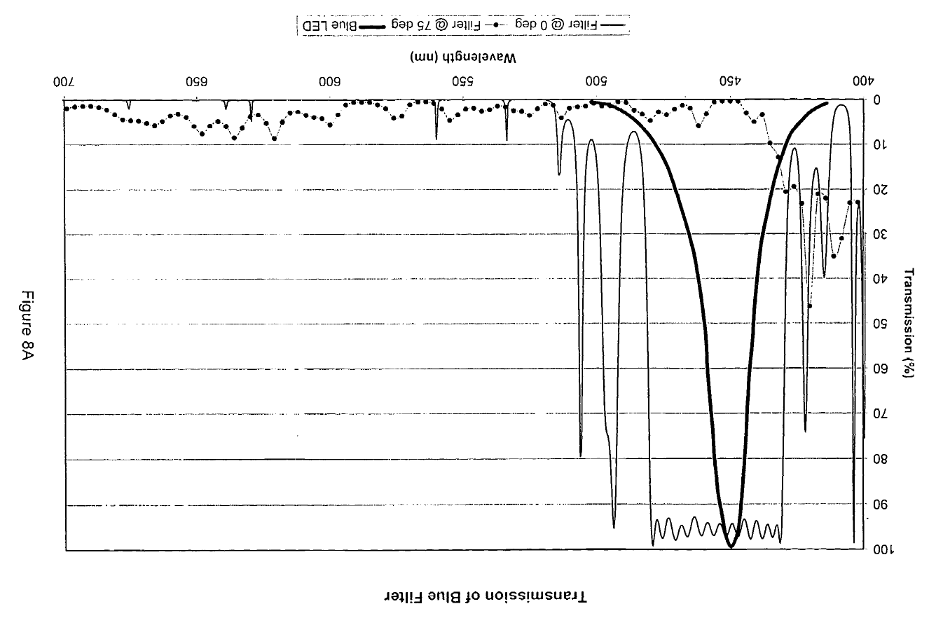

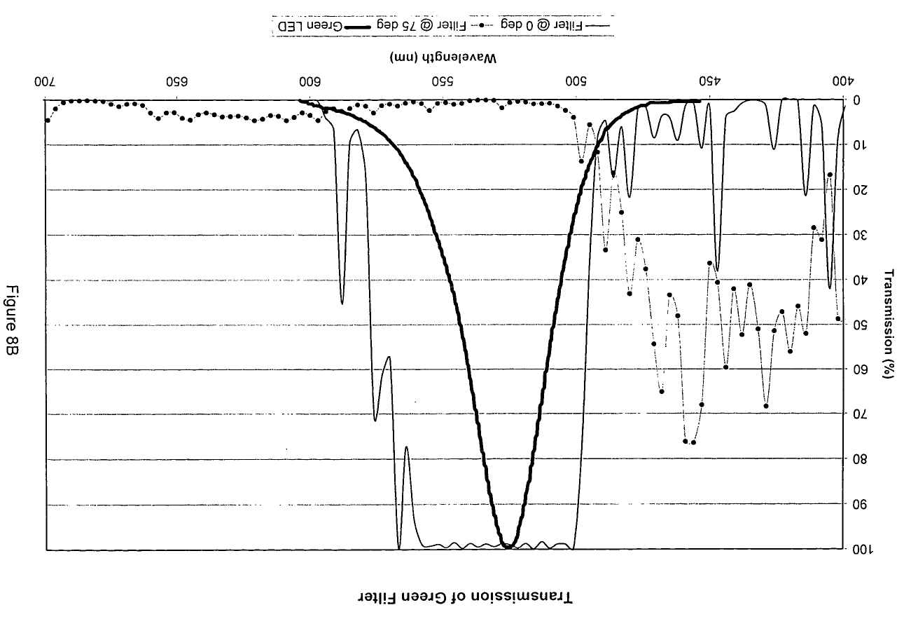

FIGS. 8A and 8B are alternative graphs that illustrate the properties of alternative pass filters in more detail. In particular, FIG. 8A is a graph that illustrates the properties of one embodiment of the blue pass filter, and FIG. 8B is a graph that illustrates the properties of one embodiment of the green pass filter. It should be noted that the coating could be designed to have other characteristics than that illustrated in FIGS. 8A and 8B.

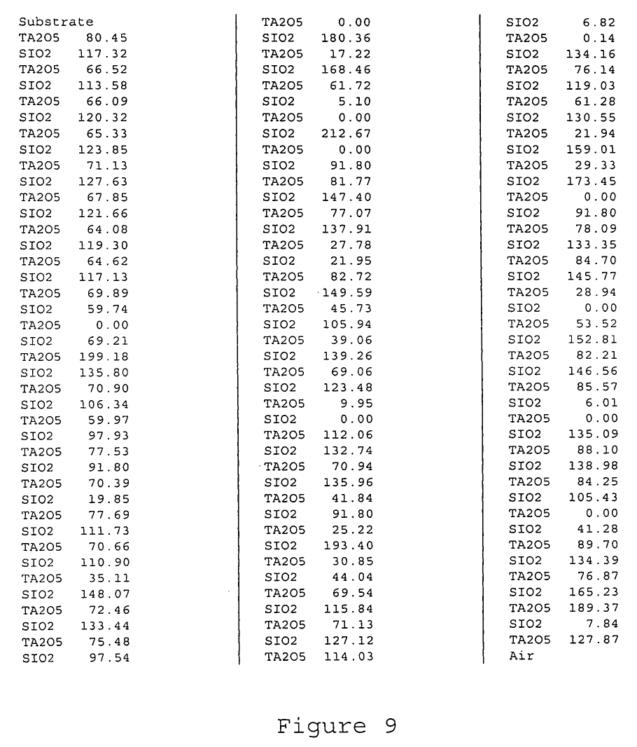

FIG. 9 is a chart that lists the layer of materials used for making a one embodiment of a blue pass filter. Starting with the substrate, the layers of materials (detail in FIG. 9) are deposited. The thickness of each layer is in nanometers.

While the particular apparatus 10 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A light source assembly for providing a homogenized light beam, the light source assembly comprising:
a first light source, a second light source, and an optical pipe that defines a pipe passageway, the first light source generating a first light that is directed into the pipe passageway at a first region, the second light source generating a second light that is directed into the pipe passageway at a second region that is different than the first region, and the optical pipe homogenizing the first light and the second light.

2. The light source assembly of claim 1 further comprising a third light source generating a third light that is directed into the optical pipe at a third region that is different than the first region and the second region, and wherein the optical pipe homogenizes the first light, the second light, and the third light.

3. The light source assembly of claim 2 further comprising (i) a first dichroic filter positioned in the pipe passageway, the first dichroic filter transmitting a high percentage of second light and reflecting a high percentage of the first light, (ii) a second dichroic filter positioned in the pipe passageway, the second dichroic filter transmitting a high percentage of third light and reflecting a high percentage of second light.

4. The light source assembly of claim 3 wherein the dichroic filters are arranged in series along a passageway axis of the pipe passageway.

5. The light source assembly of claim 1 further comprising a fourth light source generating a fourth light that is directed into the optical pipe at a fourth region that is different than the first region, the second region, and the third region, and wherein the optical pipe homogenizes the first light, the second light, the third light, and the fourth light.

6. The light source assembly of claim 1 further comprising a first pass filter that is positioned between the first light source and the pipe passageway, the first pass filter (i) transmitting a high percentage of first light that is within a first predetermined angle of incidence range, and (ii) reflecting a high percentage of the first light that is outside the first predetermined angle of incidence range.

7. The light source assembly of claim 1 wherein the first light source directs the first light into the pipe passageway transverse to a passageway axis of the pipe passageway.

8. The light source assembly of claim 7 wherein the second light source directs the second light into the pipe passageway transverse to the passageway axis of the pipe passageway.

9. The light source assembly of claim 8 wherein the first light and the second light are directed into the pipe passageway at an angle that is approximately 90 degrees relative to the passageway axis.

10. The light source assembly of claim 7 wherein the first light is directed into the pipe passageway at a different angle than which the second light is directed into the pipe passageway.

11. The light source assembly of claim 1 further comprising a first collimator that collimates the first light that is directed into the pipe passageway.

12. The light source assembly of claim 1 wherein the pipe passageway is substantially linear.

13. The light source assembly of claim 1 wherein the first light has a first average wavelength, and the second light has a second average wavelength that is longer than the first average wavelength, wherein the optical pipe includes an output end, and wherein the first light is directed into the pipe passageway closer to the output end than where the second light is directed into the pipe passageway.

14. A precision apparatus including an imager and the light source assembly of claim 1 providing a light beam that is transferred to the imager.

15. A light source assembly for providing a homogenized light beam, the light source assembly comprising:
a first light source and an optical pipe that defines a pipe passageway having a passageway axis, the first light source generating a first light that is directed into the pipe passageway transverse to the passageway axis, the optical pipe homogenizing the first light.

16. The light source assembly of claim 15 further comprising a second light source generating a second light that is directed into the pipe passageway transverse to the passageway axis, and wherein the optical pipe homogenizes the first light and the second light.

17. The light source assembly of claim 16 further comprising a third light source generating a third light that is directed into the pipe passageway transverse to the passageway axis, and wherein the optical pipe homogenizes the first light, the second light and the third light.

18. The light source assembly of claim 17 wherein the first light is directed into the optical pipe at a first region, the second light is directed into the optical pipe at a second region that is different than the first region, and the third light is directed into the optical pipe at a third region that is different than the first region and the second region.

19. The light source assembly of claim 17 further comprising (i) a first dichroic filter positioned in the pipe passageway, the first dichroic filter transmitting a high percentage of second light and reflecting a high percentage of first light, and (ii) a second dichroic filter positioned in the pipe passageway, the second dichroic filter transmitting a high percentage of third light and reflecting a high percentage of second light.

20. The light source assembly of claim 19 wherein the dichroic filters are arranged in series along a passageway axis of the pipe passageway.

21. The light source assembly of claim 16 further comprising a first dichroic filter positioned in the pipe passageway, the first dichroic filter transmitting a high percentage of second light and reflecting a high percentage of first light.

22. The light source assembly of claim 16 wherein the first light and the second light are directed into the pipe passageway at an angle that is approximately 90 degrees relative to the passageway axis.

23. The light source assembly of claim 15 further comprising a first pass filter that is positioned between the first light source and the pipe passageway, the first pass filter (i) transmitting a high percentage of first light that is within a first predetermined angle of incidence range, and (ii) reflecting a high percentage of the first light that is outside the first predetermined angle of incidence range.

24. A precision apparatus including an imager and the light source assembly of claim 15 providing a light beam that is transferred to the imager.

25. A light source assembly for providing a homogenized light beam, the light source assembly comprising:
an optical pipe that defines a pipe passageway and that homogenizes light;
a red LED generating a red light that is directed into the pipe passageway at a red region;
a green LED generating a green light that is directed into the pipe passageway at a green region that is different than the red region; and
a blue LED generating a blue light that is directed into the pipe passageway at a blue region that is different than the red region and the green region.

26. The light source assembly of claim 25 wherein at least one of the lights is directed into the pipe passageway transverse to a passageway axis of the pipe passageway.

27. The light source assembly of claim 25 wherein at least two of the lights is directed into the pipe passageway transverse to a passageway axis of the pipe passageway.

28. The light source assembly of claim 25 further comprising a red collimator that collimates the red light that is directed into the pipe passageway, a green collimator that collimates the green light that is directed into the pipe passageway, and a blue collimator that collimates the blue light that is directed into the pipe passageway.

29. The light source assembly of claim 25 wherein the pipe passageway is substantially linear.

30. The light source assembly of claim 25 wherein the optical pipe includes an output end, and wherein the blue region is closer to the output end than the red region and the green region, and the green region is closer to the output end than the red region.

31. A precision apparatus including an imager and the light source assembly of claim 25 providing a light beam that is transferred to the imager.

32. A light source assembly for providing a homogenized light beam, the light source assembly comprising:
a first light source, a second light source, an optical pipe that defines a pipe passageway, and a first dichroic filter positioned in the pipe passageway, the first light source generating a first light that is directed into the pipe passageway at a first region, the second light source generating a second light that is directed into the pipe passageway at a second region that is different than the first region, the optical pipe homogenizing the first light and the second light, and the first dichroic filter (i) transmitting a high percentage of second light and (ii) reflecting a high percentage of first light.

33. The light source assembly of claim 32 further comprising a third light source generating a third light that is directed into the optical pipe at a third region that is different than the first region and the second region, and wherein the optical pipe homogenizes the first light, the second light, and the third light.

34. The light source assembly of claim 33 further comprising a second dichroic filter positioned in the pipe passageway, the second dichroic filter transmitting a high percentage of third light and reflecting a high percentage of second light.

35. The light source assembly of claim 34 wherein the dichroic filters are arranged in series along a passageway axis of the pipe passageway.

36. The light source assembly of claim 32 wherein the first dichroic filter is an interference filter having an effective index of at least approximately 1.75.

37. The light source assembly of claim 32 wherein the first dichroic filter is plate type filter.

38. A light source assembly for providing a homogenized light beam, the light source assembly comprising:
an optical pipe that defines a pipe passageway and that homogenizes light;
a first LED generating a first light that is directed into the pipe passageway at a first port;
a second LED generating a second light that is directed into the pipe passageway at a second port that is different than the first port;
a third LED generating a third light that is directed into the pipe passageway at a third port that is different than the first port and the second port;
a first collimator that collimates the first light that is directed into the pipe passageway;
a second collimator that collimates the second light that is directed into the pipe passageway;
a third collimator that collimates the third light that is directed into the pipe passageway;
a first dichroic filter positioned in the pipe passageway between the first port and the second port, the first dichroic filter transmitting a high percentage of second light and reflecting a high percentage of the first light; and
a second dichroic filter positioned in the pipe passageway between the first port and the second port, the second dichroic filter transmitting a high percentage of third light and reflecting a high percentage of second light.

39. The light source assembly of claim 38 wherein at least one of the lights is directed into the pipe passageway transverse to a passageway axis of the pipe passageway.

40. The light source assembly of claim 38 further comprising (i) a first pass filter that is positioned between the first LED and the pipe passageway, the first pass filter transmitting a high percentage of first light that is within a first predetermined angle of incidence range, and reflecting a high percentage of the first light that is outside the first predetermined angle of incidence range; (ii) a second pass filter that is positioned between the second LED and the pipe passageway, the second pass filter transmitting a high percentage of second light that is within a second predetermined angle of incidence range, and reflecting a high percentage of the second light that is outside the second predetermined angle of incidence range; and (iii) a third pass filter that is positioned between the third LED and the pipe passageway, the third pass filter transmitting a high percentage of third light that is within a third predetermined angle of incidence range, and reflecting a high percentage of the third light that is outside the third predetermined angle of incidence range;

41. A precision apparatus including an imager and the light source assembly of claim 40 providing a light beam that is transferred to the imager.

42. A method for providing a homogenized light beam for a precision apparatus, the method comprising the steps of:
generating a first light with a first light source;
generating a second light with a second light source; and
homogenizing the first light and the second light with an optical pipe that defines a pipe passageway, wherein the first light is directed into the pipe passageway at a first region, and the second light is directed into the pipe passageway at a second region that is different than the first region.

43. The method of claim 42 further comprising the step of generating a third light with a third light source that is directed into the optical pipe at a third region that is different than the first region and the second region.

44. The method of claim 42 further comprising the step of positioning a first pass filter between the first light source and the pipe passageway, the first light filter (i) transmitting a high percentage of first light that is within a first predetermined angle of incidence range, and (ii) reflecting a high percentage of the first light that is outside the first predetermined angle of incidence range.

45. The method of claim 42 further comprising the step of positioning a first dichroic filter in the pipe passageway, the first dichroic filter (i) transmitting a high percentage of second light, and (ii) reflecting a high percentage of first light.
